(19) United States
(12) Patent Application Publication
(10) Pub. No.: US 2006/0245501 A1
(43) Pub. Date: Nov. 2, 2006

(54) Combined filter processing for video compression

(76) Inventors: Stephen Gordon, (US); Christopher Payson, (US)

Correspondence Address: MCANDREWS HELD & MALLOY, LTD, 500 WEST MADISON STREET, SUITE 3400, CHICAGO, IL, 60661, US

(21) Appl. No.: 11/172,645

(22) Filed: Jun. 29, 2005

Related U.S. Application Data
(60) Provisional application No. 60/675,145, filed on Apr. 27, 2005.

(51) Int. Cl. H04N 11/04; H04N 7/12; H04B 1/66; H04N 11/02

(52) U.S. Cl. 375/240.24

(57) ABSTRACT

Presented herein are combined filter(s) for video compression. In one embodiment, there is presented a method for overlap transforming a block. The method comprises filtering a portion of a horizontal edge of a block; and overlap transform filtering a vertical edge of the block after filtering the portion of the horizontal edge of the block.

### RELATED APPLICATIONS

This application claims priority to “Combined Filter Processing for Video Compression”, Provisional Application for U.S. patent Ser. No. 60/675,145, filed Apr. 27, 2005, by Payson, et. al, which is incorporated by reference herein for allow purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

There are a variety of standards for encoding and compressing video data. Among the standards are MPEG-2, the ITU-H.264 Standard (H.264) (also known as MPEG-4, Part 10, and Advanced Video Coding), and VC-1.

A decoder that is capable of decoding video data encoded with numerous standards is also capable of decoding a greater amount of video content. However, the foregoing standards have a number of differences that complicate the decoding.

The MPEG-2, H.264, and VC-1 standards have a number of differences. For example, the VC-1 standard uses quantized frequency coefficient prediction. Quantized frequency coefficient prediction is not used in either MPEG-2 or H.264. Additionally, MPEG-2 and H.264 use different scale factors for AC components, while VC-1 uses the same scale factors for the AC components. MPEG-2, H.264, and VC-1 also use different scan tables, blocks, and transformation blocks.

Additional limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Aspects of the present invention may be found in system(s), method(s), and apparatus for combined filtering for video compression, substantially as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram of an exemplary frame;

FIG. 2A is a block diagram describing spatially predicted macroblocks;

FIG. 2B is a block diagram describing temporally predicted macroblocks;

FIG. 2C is a block diagram describing the encoding of a prediction error;

FIG. 3 is a block diagram of a video decoder in accordance with an embodiment of the present invention;

FIG. 4 is a block diagram of an exemplary deblocker in accordance with an embodiment of the present invention

FIG. 5 is a flow diagram for overlap transforming a block in accordance with an embodiment of the present invention;

FIG. 6 is a flow diagram for deblocking a block in accordance with an embodiment of the present invention;

FIG. 7 is a block diagram describing the overlap transformation for vertical edges, in accordance with an embodiment of the present invention;

FIG. 8 is a block diagram describing the overlap transformation for horizontal edges, in accordance with an embodiment of the present invention;

FIG. 9 is a block diagram describing overlap transformation results, in accordance with an embodiment of the present invention;

FIG. 10 is a block diagram describing the deblocking of 8×8 aligned horizontal edges, in accordance with an embodiment of the present invention;

FIG. 11 is a block diagram describing the deblocking of non 8×8 aligned horizontal edges, in accordance with an embodiment of the present invention;

FIG. 12 is a block diagram describing the deblocking of 8×8 aligned vertical edges, in accordance with an embodiment of the present invention;

FIG. 13 is a block diagram describing the deblocking of 8×8 aligned vertical edges, in accordance with an embodiment of the present invention;

FIG. 14 is a block diagram describing the deblocking and overlap transformation results, in accordance with an embodiment of the present invention; and

FIG. 15 is a block diagram describing the storage of macroblocks, in accordance with an embodiment of the present invention.

### DETAILED DESCRIPTION OF THE INVENTION

According to certain aspects of the present invention, a deblocker overlap transforms and deblocks reconstructed pixel data. An exemplary video encoding standard, VC-1, will now be described, followed by an description of exemplary video decoder in accordance with an embodiment of the present invention.

VC-1 Standard

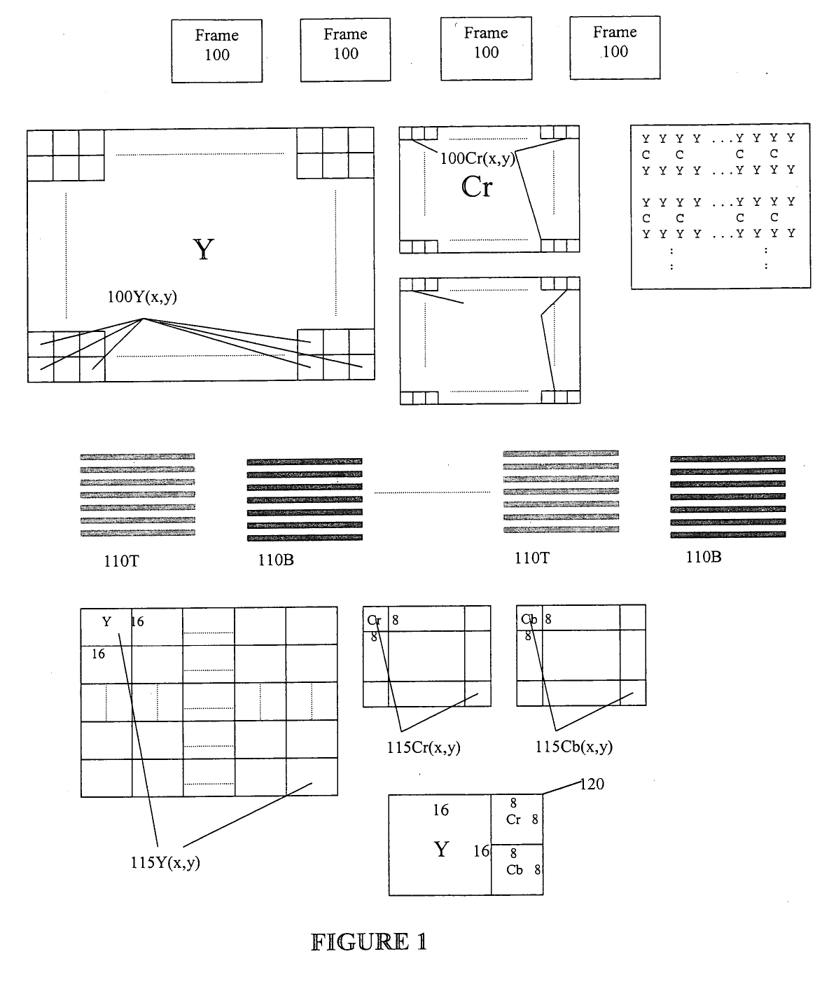

Referring now to FIG. 1, there is illustrated a block diagram of a frame 100. A video camera captures frames 100 from a field of view during time periods known as frame durations. The successive frames 100 form a video sequence. A frame 100 comprises two-dimensional grid(s) of pixels 100(x,y).

For color video, each color component is associated with a two-dimensional grid of pixels. For example, a video can include luma, chroma red, and chroma blue components. Accordingly, the luma, chroma red, and chroma blue components are associated with a two-dimensional grid of pixels 100Y(x,y), 100Cr(x,y), and 100Cb(x,y), respectively. When the grids of two dimensional pixels 100Y(x,y), 100Cr(x,y), and 100Cb(x,y) from the frame are overlayed on a display device 110, the result is a picture of the field of view at the frame duration that the frame was captured.

Generally, the human eye is more perceptive to the luma characteristics of video, compared to the chroma red and chroma blue characteristics. Accordingly, there are more pixels in the grid of luma pixels 100Y(x,y) compared to the grids of chroma red 100Cr(x,y) and chroma blue 100Cb(x,y). In an exemplary 4:2:0 standard, the grids of chroma red 100Cr(x,y) and chroma blue pixels 100Cb(x,y) have half as many pixels as the grid of luma pixels 100Y(x,y) in each direction.

The chroma red 100Cr(x,y) and chroma blue 100Cb(x,y) pixels are overlayed the luma pixels in each even-numbered column 100Y(x, 2y) between each even, one-half a pixel below each even-numbered line 100Y(2x, y). In other words, the chroma red and chroma blue pixels 100Cr(x,y) and 100Cb(x,y) are overlayed pixels 100Y(2x+½, 2y).

If the video camera is interlaced, the video camera captures the even-numbered lines 100Y(2x,y), 100Cr(2x,y), and 100Cb(2x,y) during half of the frame duration (a field duration), and the odd-numbered lines 100Y(2x+1,y), 100Cr(2x+1,y), and 100Cb(2x+1,y) during the other half of the frame duration. The even numbered lines 100Y(2x,y), 100Cr(2x,y), and 100Cb(2x,y) form what is known as a top field 110T, while odd-numbered lines 100Y(2x+1,y), 100Cr(2x+1,y), and 100Cb(2x+1,y) form what is known as a bottom field 110B. The top field 110T and bottom field 110B are also two dimensional grid(s) of luma 110YT(x,y), chroma red 110CrT(x,y), and chroma blue 110CbT(x,y) pixels.

Luma pixels of the frame 100Y(x,y), or top/bottom fields 110YT/B(x,y) can be divided into 8×8 pixel 100Y(8x->8x+7, 8y->8y+7) blocks 115Y(x,y). For every four blocks of luma pixels 115Y(x,y), there is a corresponding 8×8 block of chroma red pixels 115Cr(x,y) and chroma blue pixels 115Cb(x,y) comprising the chroma red and chroma blue pixels that are to be overlayed the blocks of luma pixels 115Y(x,y). The four 8×8 blocks of luma pixels 115Y(x,y), and the corresponding 8×8 blocks of chroma red pixels 115Cr(x,y) and chroma blue pixels 115Cb(x,y) are collectively known as a macroblock 120. The macroblocks 120 can be grouped into groups known as slice groups 122.

The standards encode video on a frame by frame basis, and encode frames on a macroblock by macroblock basis. VC-1 specifies the use of frequency coefficient prediction, temporal prediction, and transformations to compress macroblocks.

Unless otherwise specified, the pixel dimensions for a unit, such as a macroblock or partition, shall refer to the dimensions of the luma pixels of the unit. Also, and unless otherwise specified, a unit with a given pixel dimension shall also include the corresponding chroma red and chroma blue pixels that overlay the luma pixels. The dimensions of the chroma red and chroma blue pixels for the unit depend on whether MPEG 4:2:0, MPEG 4:2:2 or other format is used, and may differ from the dimensions of the luma pixels.

Spatial Prediction

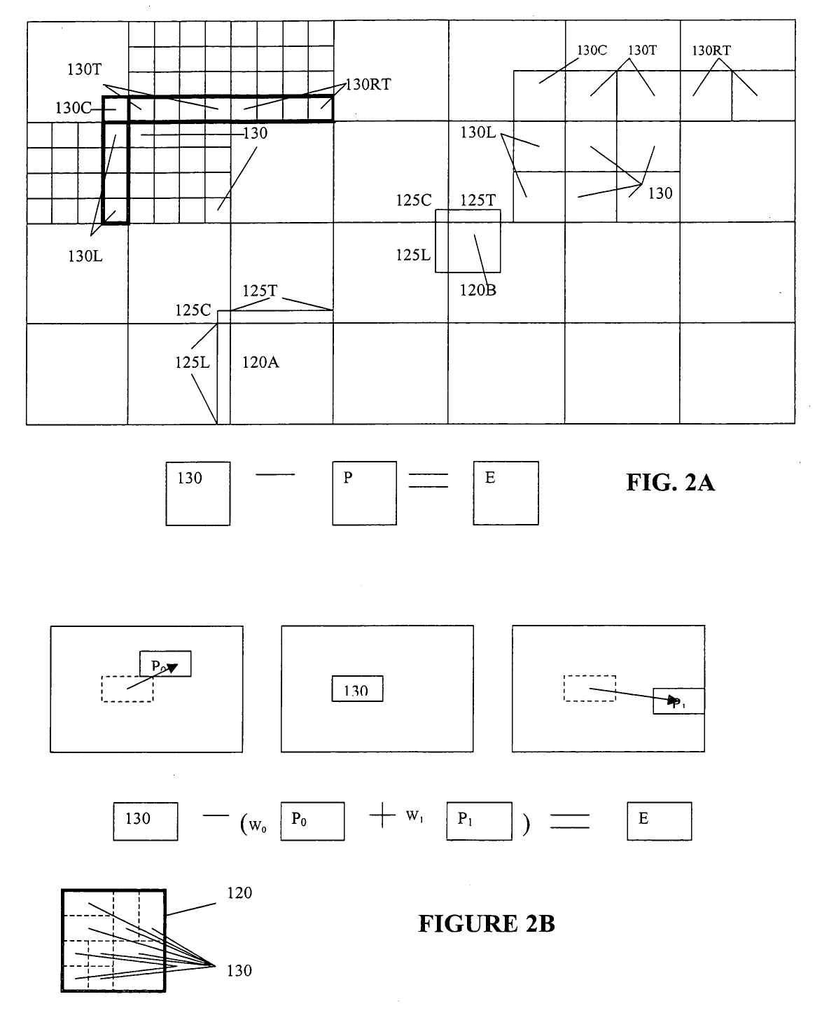

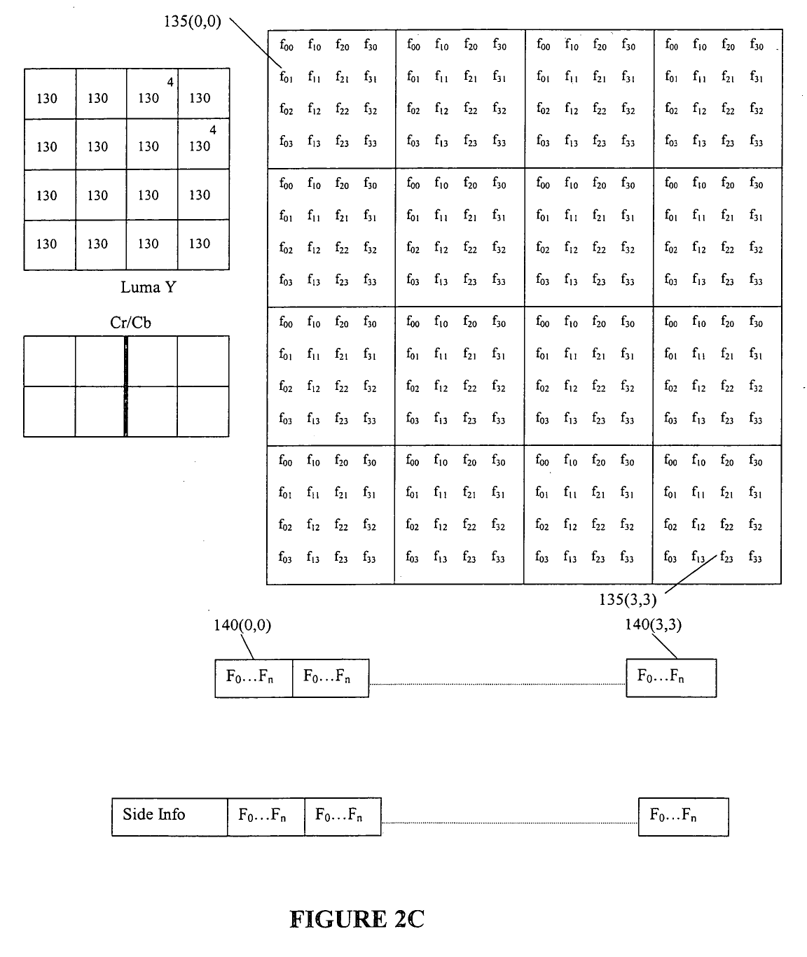

Referring now to FIG. 2A, there is illustrated a block diagram describing spatially encoded macroblocks 120. Spatial prediction, also referred to as intraprediction, involves prediction of pixels from neighboring pixels. The pixels of a macroblock 120 can be predicted, either in a 16×16 mode, an 8×8 mode, or a 4×4 mode.

In the 16×16 and 8×8 modes, e.g, macroblock 120a, and 120b, respectively, the pixels of the macroblock are predicted from a combination of left edge pixels 125L, a corner pixel 125C, and top edge pixels 125T. The difference between the macroblock 120a and prediction pixels P is known as the prediction error E. The prediction error E is calculated and encoded along with an identification of the prediction pixels P and prediction mode, as will be described.

In the 4×4 mode, the macroblock 120c is divided into 4×4 partitions 130. The 4×4 partitions 130 of the macroblock 120a are predicted from a combination of left edge partitions 130L, a corner partition 130C, right edge partitions 130R, and top right partitions 130TR. The difference between the macroblock 120a and prediction pixels P is known as the prediction error E. The prediction error E is calculated and encoded along with an identification of the prediction pixels and prediction mode, as will be described. A macroblock 120 is encoded as the combination of the prediction errors E representing its partitions 130.

Temporal Prediction

VC-1 specifies the use of temporal prediction. Referring now to FIG. 2B, there is illustrated a block diagram describing temporally encoded macroblocks 120. In H.264 and VC-1, the temporally encoded macroblocks 120 can be divided into 16×8, 8×16, 8×8, 4×8, 8×4, and 4×4 blocks 130. In MPEG-2, 8×8 blocks are used. Each partition 130 of a macroblock 120, is compared to the pixels of other frames or fields for a similar block of pixels P. A macroblock 120 is encoded as the combination of the prediction errors E representing its partitions 130.

The similar block of pixels is known as the prediction pixels P. The difference between the partition 130 and the prediction pixels P is known as the prediction error E. The prediction error E is calculated and encoded, along with an identification of the prediction pixels P. The prediction pixels P are identified by motion vectors MV. Motion vectors MV describe the spatial displacement between the block 130 and the prediction pixels P.

The partition can also be predicted from blocks of pixels P in more than one field/frame. In bi-directional coding, the block 130 can be predicted from two weighted blocks of pixels, P0 and P1. According a prediction error E is calculated as the difference between the weighted average of the prediction blocks w0P0+w1P1 and the block 130. The prediction error E, an identification of the prediction blocks P0, P1 are encoded. The prediction blocks P0 and P1 are identified by motion vectors MV.

The weights w0, w1 can also be encoded explicitly, or implied from an identification of the field/frame containing the prediction blocks P0 and P1. The weights w0, w1 can be implied from the distance between the frames/fields containing the prediction blocks P0 and P1 and the frame/field containing the block 130. Where T0 is the number of frame/field durations between the frame/field containing P0 and the frame/field containing the partition, and T1 is the number of frame/field durations for P1,
w0=1−T0/(T0+T1)
w1=1−T1/(T0+T1)

For a high definition television picture, there are thousands of macroblocks 120 per frame 100. The macroblocks 120, themselves can be partitioned into potentially 16 4×4 blocks 130, each associated with potentially different motion vector sets. Thus, coding each of the motion vectors without data compression can require a large amount of data and bandwidth.

Transformation, Quantization, and Scanning

Referring now to FIG. 2C, there is illustrated a block diagram describing the encoding of the prediction error E. With both spatial prediction and temporal prediction, the macroblock 120 is represented by a prediction error E. The prediction error E is also two-dimensional grid of pixel values for the luma Y, chroma red Cr, and chroma blue Cb components with the same dimensions as the macroblock 120.

A transformation transforms blocks 130 of the prediction error E to the frequency domain. In VC-1, the blocks can be 4×4, 4×8, 8×4, or 8×8. The foregoing results in sets frequency coefficients f₀₀ . . . fₙₙ, with the same dimensions as the block size. The sets of frequency coefficients are then quantized, resulting in sets 140 of quantized frequency coefficients, F₀₀ . . . Fₙₙ. In VC-1, the same scale factor is used for each DC quantized frequency coefficient F₀₁ . . . Fₙₙ.

VC-1 uses quantized frequency coefficient prediction to predict either the first row F₀₀ . . . F₀ₙ, or first column F₀₀ . . . Fₙ₀, from the top row F₀₀ . . . F₀ₙ of a top neighboring block 130, or the left column of a left neighboring block 130. Where quantized frequency prediction is used, if the absolute difference between coefficient F₀₀ from the top neighboring block 130 and coefficient F₀₀ is less than the absolute difference between coefficient F₀₀ from the left neighboring block 130 and coefficient F₀₀, the top row F₀₀ . . . F₀ₙ is predicted from the top row F₀₀ . . . F₀ₙ of the top neighboring block 130. Otherwise, the left column F₀₀ . . . Fₙ₀ is predicted from the left column F₀₀ . . . F₀ₙ of the left neighboring block 130. The predicted quantized coefficients ΔF₀₀ . . . ΔF₀ₙ are the difference between the top row F₀₀ . . . F₀ₙ/left column F₀₀ . . . Fₙ₀ and the top row F₀₀ . . . F₀ₙ/left column F₀₀ . . . Fₙ₀ of the top neighboring block/left neighboring block.

The blocks of quantized frequency coefficients or predicted quantized frequency coefficients are then scanned. In VC-1, where quantized frequency prediction is used, the scanning technique used depends on whether the top row or left column is predicted.

The scanning reorders the frequency coefficients in a manner that is likely to place the quantized frequency coefficients with the greatest magnitude first, followed by the quantized frequency coefficients with lower magnitudes, and quantized frequency coefficients with zero magnitude last. The scanned and quantized frequency coefficients can then be coded as run level pairs. Run level pairs include levels L representing a quantized frequency coefficient, followed by a run R indicating the number of quantized frequency coefficients that follow that are zero (if any).

The frames 100 are encoded as the macroblocks 120 forming them. The video sequence is encoded as the frame forming it. The encoded video sequence is known as a video elementary stream. The video elementary stream is a bitstream that can be transmitted over a communication network to a decoder. Transmission of the bitstream instead of the video sequence consumes substantially less bandwidth.

As can be seen from the foregoing discussion, the video data is compressed and encoded in blocks. A common problem that can occur when the video data is reconstructed from the blocks is discontinuities at the edges of the blocks. This can cause grid lines at the block edges that are perceivable. Deblocking and overlap transformations are used to prevent this.

Video Decoder

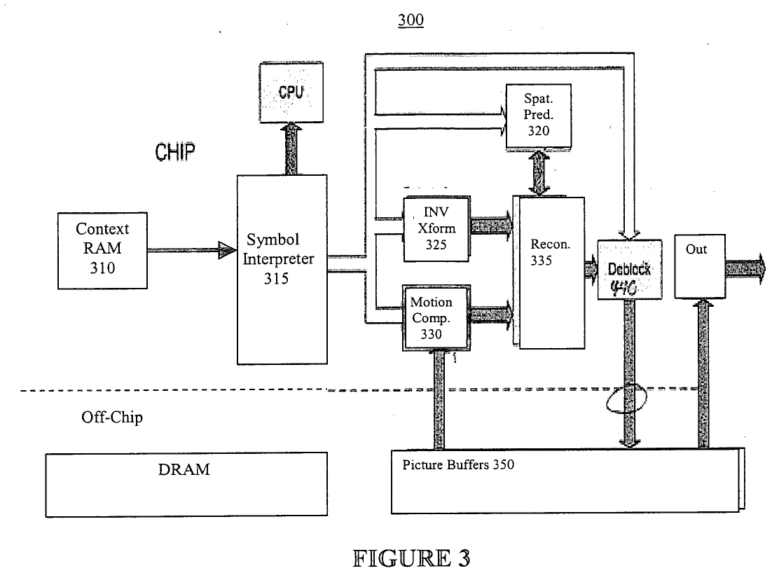

Referring now to FIG. 3, there is illustrated a block diagram describing an exemplary video decoder 300 in accordance with an embodiment of the present invention. The video decoder 300 includes a code buffer 305 for receiving a video elementary stream. The code buffer 305 can be a portion of a memory system, such as a dynamic random access memory (DRAM). A symbol interpreter 315 in conjunction with a context memory 310 decode the CABAC and CAVLC symbols from the bitstream. The context memory 310 can be another portion of the same memory system as the code buffer 305, or a portion of another memory system.

The symbol interpreter 315 provides the sets of scanned quantized frequency coefficients to an inverse scanner, quantizer, and transformer (ISQT) 325. Depending on the prediction mode for the macroblock 120 associated with the scanned quantized frequency coefficients, the symbol interpreter 315 provides the side information to either a spatial predicter 320 (if spatial prediction) or a motion compensator 330 (if temporal prediction).

The ISQT 325 constructs the prediction error E. The spatial predictor 320 generates the prediction pixels P for spatially predicted macroblocks while the motion compensator 330 generates the prediction pixels P, or P0, P1, for temporally predicted macroblocks. The motion compensator 330 retrieves the prediction pixels P, or P0, P1, from picture buffers 350 that store previously decoded frames 100 or fields 110.

A pixel reconstructor 335 receives the prediction error E from the ISQT 325, and the prediction pixels from either the motion compensator 330 or spatial predictor 320. The pixel reconstructor 335 reconstructs the macroblock 120 from the foregoing information and provides the macroblock 120 to a deblocker 340.

The deblocker 340 overlap transforms and deblocks the pixels near the edges of the macroblock 120 to prevent the appearance of blocking. The deblocker 340 writes the decoded macroblock 120 to the picture buffer 350.

In certain embodiments of the present invention, the pixel reconstructor 335 and deblocker 340 can work together in a pipelined fashion. For example, the pixel reconstructor 335 can reconstruct a first macroblock. After the pixel reconstructor 335 reconstructs the first macroblock, the deblocker 440 can overlap transform and deblock a 16×16 block that straddles the first macroblock, its left, top, and top left neighbor, while the pixel reconstructor 335 reconstructs another macroblock.

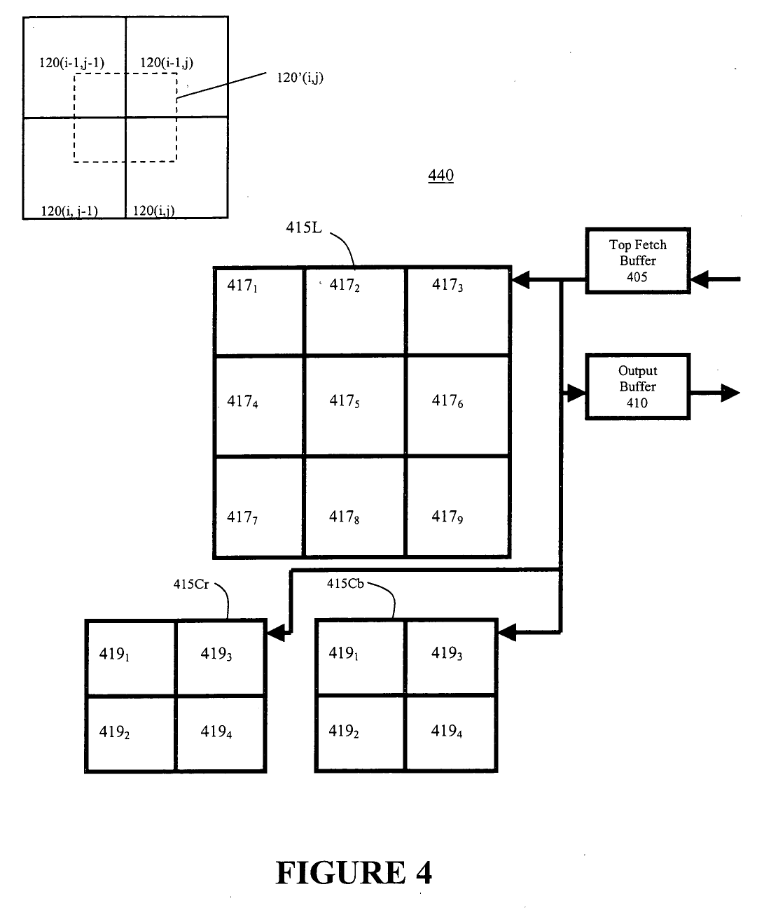

Referring now to FIG. 4 there is illustrated a block diagram describing an exemplary deblocker 440 in accordance with an embodiment of the present invention. The deblocker 440 comprises a top fetch buffer 405, an output buffer 410, a luma working memory 415L, chroma red working memory 415Cr, chroma blue working memory 415Cb, and a filtering engine 420. In certain embodiments, the top fetch buffer 405, an output buffer 410, luma working memory 415L, chroma red working memory 415Cr, can comprise on-chip memory such as SRAM or a register-file based memory.

The luma working memory 415L has the capacity to store nine luma 8×8 blocks in memory 417₁ . . . 417₉. Four 8×8 luma blocks of reconstructed macroblock 120(i,j) can be stored in memory 417₅, 417₆, 417₈, 417₉, the bottom two 8×8 blocks of a top neighboring macroblock 120(i−1, j) can be stored at memory 417₂, 417₃, the right two 8×8 blocks of a left neighboring macroblock 120(i, j−1), can be stored at memory 417₄, 417₇ and the bottom right 8×8 block of macroblock 120(i−1, j−1), can be stored at memory 417₁.

As noted above, after the reconstructor 435 reconstructs a macroblock 120(i,j), the deblocker 440 completes the overlap transformation and deblocking of a 16×16 luma block 120′(i,j) that straddles macroblock 120(i,j), its left 120(i,j−1), top 120(i−1, j), and top left neighbor 120(i−1,j−1).

The working memory 415L receives the blocks stored in memory 417₅, 417₆, 417₈, 417₉, from the reconstructor 435. The blocks stored in memory 417₂, 417₃ are received from the top fetch buffer 405. While the deblocker 440 overlap transformed and deblocked block 120′(i,j−1), the deblocker 440 fetched the blocks of top neighboring macroblock 120(i−1, j) that are stored at memory 417₂, 417₃. While the deblocker 440 overlap transforms and deblocks block 120′(i,j), the deblocker 440 fetches the blocks 417₂, 417₃ for deblocking 120′(i,j+1)

The blocks stored in memory 417₁, 417₄, 417₇ are available in the working memory 415L after deblocking and overlap transforming block 120′(i,j−1). After deblocking and overlap transforming block 120′(i,j), the blocks stored in memory 417₃, 417₆, 417₉ are the blocks stored in memory 417₁, 417₄, 417₇ for the next macroblock 120(i,j+1) to be received from the reconstructor 435.

In certain embodiments of the present invention, pointers can designate the portions that are 417₁, 417₄, 417₇, and 417₃, 417₆, 417₉. Portions 417₂, 417₅, 417₈ can also be designated by pointers. After overlap transforming and deblocking block 120′(i, j), the pointers can swap for the next macroblock. For the remainder of this discussion, the numeral reference 417₁, shall refer to the portion of working memory 415L that stores a block from the top left neighbor 120 (i−1, j−1), 417₄ and 417₇ shall refer to the portions of working memory 415L that stores blocks from the left neighbor 120 (i, j−1), 417₃ shall refer to the portion of working memory 415L that stores a block from the top neighbor 120(i−1, j), and 417₆ and 417₉ shall refer to the portions of working memory 415L that store blocks from the macroblock 120(i,j).

The filtering engine 420 completes the overlap transformation and deblocking for the 16×16 luma block that comprises the blocks that are stored in 417₁, 417₂, 417₄, and 417₅. After the filtering engine 420 completes the overlap transformation and dedeblocking of the blocks stored in 417₁, 417₂, 417₄, and 417₅, the foregoing blocks are written to the output buffer 410. The contents of the output buffer 410 are written to DRAM.

According to certain aspects of the present invention, the filtering engine 420 can overlap transform and deblock in multiple passes at different times. Thus, the blocks stored at 417₃, 417₆, 417₇, 417₈, and 417₉ can be partially overlap transformed and deblocked. The remainder can be performed with other macroblocks.

The chroma red/blue working memory 415Cr/415Cb (415C) have the capacity 419₁, 419₂, 419₃, and 419₄, to store chroma red/blue blocks from the top left 120(i−1,j−1), left 120(i,j−1), and top 120(i−1,j) neighbors, respectively, of newly reconstructed chroma red/blue blocks from macroblock 120(i,j). The top fetch buffer 405 fetches the chroma red/blue blocks from the top neighboring macroblock 120(i−1,j), while the chroma red/blue blocks from the new reconstructed macroblock 120(i,j) are received by the reconstructor. The foregoing blocks are the left and top left neighbors for the next macroblock 120(i,j+1) that is reconstructed. Thus, the top fetch buffer 405 can fetch only the chroma red/blue blocks of the top neighboring macroblock.

After receiving the chroma red/blue block of macroblock 120(i,j), the filter engine 420 completes the overlap transformation and deblocking of the chroma red/blue block of top left neighboring macroblock 120(i−1,j−1) in memory 419₁.

According to certain aspects of the present invention, the filtering engine 420 can overlap transform and deblock in multiple passes at different times. Thus, the chroma red/blue blocks stored at memory 419₂, 419₃, and 419₄, can be partially overlap transformed and deblocked. The remainder can be performed with chroma red/blue blocks from other macroblocks.

In certain embodiments of the present invention, pointers can designate the portions that are 419₁, 419₃, and the portions that are 419₂, and 419₄. After overlap transforming and deblocking the block in memory 419₁, the pointers can swap for the next macroblock. For the remainder of this discussion, the numeral reference 419₁, shall refer to the portions of working memory 415C that stores chroma red/blue blocks from the top left neighbor 120(i−1, j−1), 419₂ shall refer to the portions of working memory 415C that store chroma red/blue blocks from the left neighbor 120(i, j−1), 419₃ shall refer to the portions of working memory 415C that store chroma red/blue blocks from the top neighbor 120(i−1, j), and 419₄ shall refer to the portions of working memory 415C that store the chroma red/blue blocks from the macroblock 120(i,j).

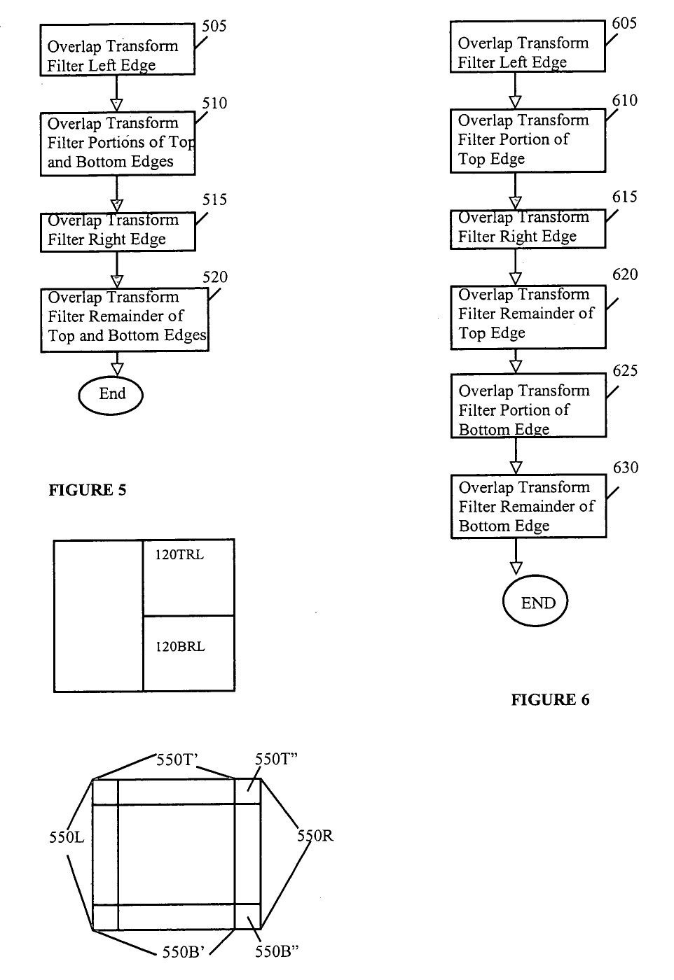

Referring now to FIG. 5, there is illustrated a flow diagram describing the overlap transformation of a block in accordance with an embodiment of the present invention. The block can comprise, for example, a top right luma block 120TRL of a macroblock.

The left edge 550L of the block is overlap transform filtered (505), followed by a portion of the top 550T′ and bottom 550′B edges of the block (510), followed by the right edge 550R (515), and the remaining portions of the top 550T″ and bottom 550B″ edges (520). It is noted that the remaining portions 550T″ and 550B″ can overlap the right edge 550R.

Referring now to FIG. 6, there is illustrated a flow diagram for overlap transforming a block in accordance with another embodiment of the present invention. The block can comprise, for example, the bottom right luma block 120BRL, a chroma red, or blue block of a macroblock 120.

The left edge 550L of the block is overlap transformed filtered (605), followed by a portion of the top edge 550T′ (610), followed by the right edge 550R (615), followed by the remainder of the top edge 550T″ (620), followed by a portion of the bottom edge 550B′ (625), followed by the remainder of the bottom edge 550B″ (630).

For FIGS. 7-15, the indicator “O” signifies that the pixel has been modified during the overlap transformation process. The indicator “D” indicates that the pixel has been modified during the deblocking process. The indicator “B” indicates that the pixel has been modified during both the overlap transformation and deblocking. The pixels that are shaded indicate the pixel is input to the filtering engine 620.

Referring now to FIG. 7, there is illustrated a block diagram describing the overlap transforming of vertical edges, in accordance with an embodiment of the present invention. The filtering engine 620 applies a horizontal filter to the two columns of pixels (bands 701, 702, 703) that are along either side of the left vertical borders of the blocks stored in memory 417₅, 417₆, 417₈, 417₉, and 419₄.

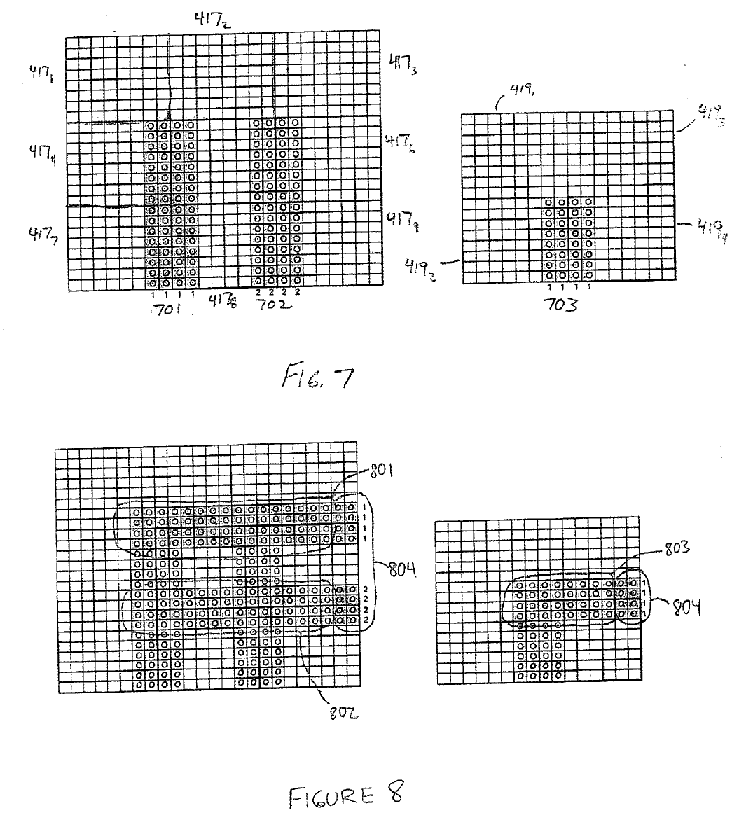

Referring now to FIG. 8, there is illustrated a block diagram describing the overlap transforming of horizontal edges, in accordance with an embodiment of the present invention. The filtering engine 420 applies a vertical filter to the two rows of pixels (bands 801, 802, and 803) that are along either side of the top vertical borders of blocks stored in memory 417₅, 417₆, 417₈, 417₉, and 419₄ and with the exception of the two columns of pixels (band 804) that are along the right vertical border of blocks in memory 417₆, 417₉, and memory 419₄. The filtering engine 420 applies the vertical filter to the pixels in band 804 after the next macroblock is received from the reconstructor.

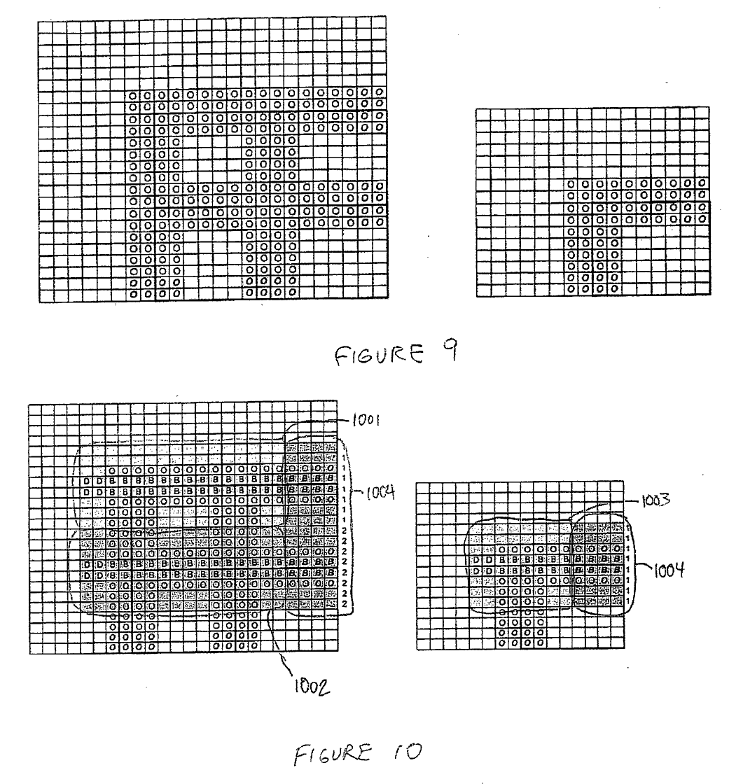

Referring now to FIG. 9, there is illustrated a block diagram describing the overlap transform results, in accordance with an embodiment of the present invention.

Referring now to FIG. 10, there is illustrated a block diagram describing the deblocking of 8×8 aligned horizontal edges, in accordance with an embodiment of the present invention. The filtering engine 420 applies a vertical filter to the four rows of pixels that are along the horizontal border of the blocks in memory 417₅, 417₈, the right half of blocks in memory 417₄, 417₇, and the left half of blocks in memory 417₆, 417₉ (bands 1001, 1002).

For the chroma red/blue pixels, the filtering engine 420 applies a vertical filter to the four rows of pixels (band 1003) in the right half of the blocks in 419₁, and 419₃, and the left half of the blocks in 419₂ and 419₄.

The filtering engine 420 applies the vertical filter to the pixels in band 1004 after the next macroblock is reconstructed. The pixels that are adjacent to the block boundaries are changed. The remaining pixels are inputs to the vertical filter but are not changed.

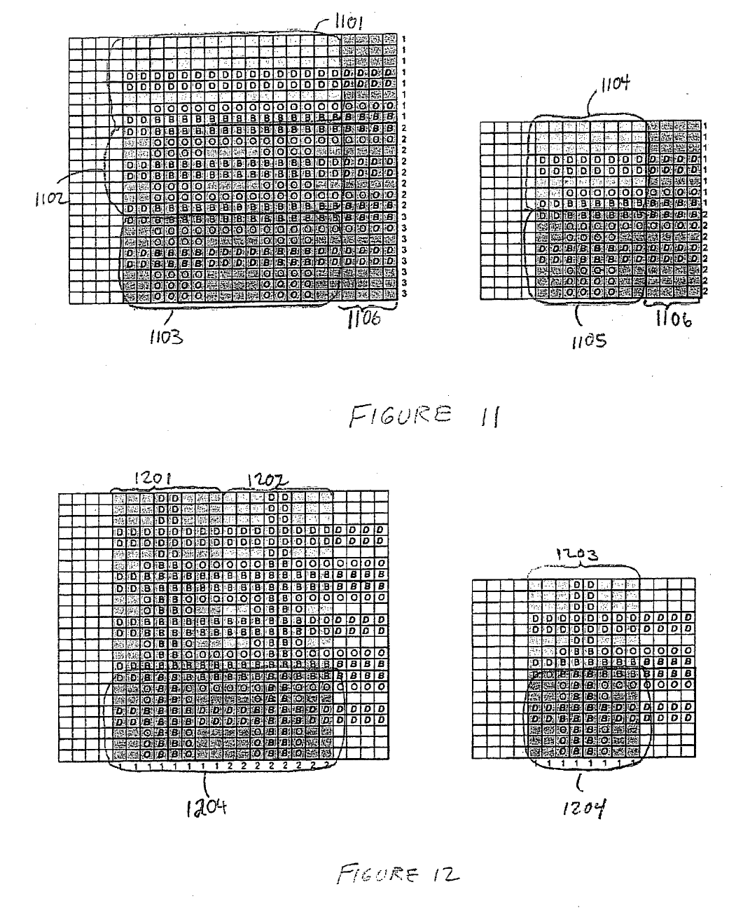

Referring now to FIG. 11, there is illustrated a block diagram describing the deblocking of non-8×8 aligned horizontal edges, in accordance with an embodiment of the present invention. The filtering engine 420 applies a vertical filter to the four rows of pixels that are along the 4×4 partition horizontal borders of blocks stored in memory 417₂, 417₅, 417₈, the right half of blocks stored in memory 417₁, 417₄, 417₇, 419₁, 419₂, and the left half of blocks stored in memory 417₃, 417₆, 417₉, 419₃, 419₄, (bands 1101, 1102, 1103, 1004, and 1105). The pixels that are adjacent to the block boundaries are changed. The filtering engine 420 applies the vertical filter to the pixels in band 1106 after the next macroblock is reconstructed.

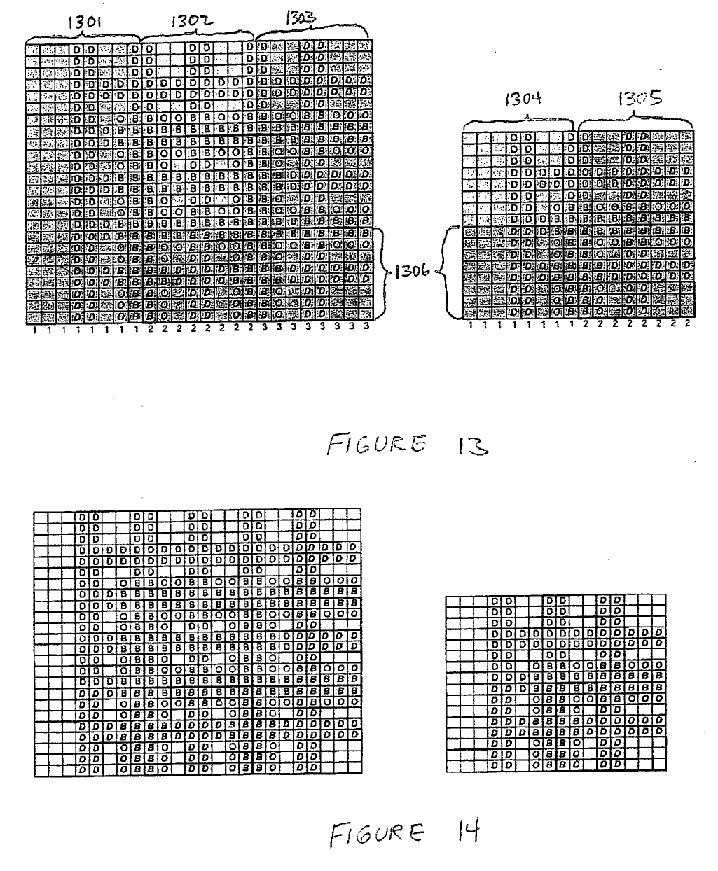

Referring now to FIG. 12, there is illustrated a block diagram describing the deblocking of 8×8 aligned vertical edges, in accordance with an embodiment of the present invention. The filtering engine 420 applies a horizontal filter to the four columns of pixels that are along the vertical borders of blocks 417₂, 417₃, 417₅, 417₆, 419₁, and 419₃, (bands 1201, 1202, and 1203). The filtering engine applies the horizontal filter to the pixels in band 1204 after the next macroblock is reconstructed.

Referring now to FIG. 13, there is illustrated a block diagram describing the deblocking of non 8×8 aligned vertical edges, in accordance with an embodiment of the present invention. The filtering engine 420 applies a horizontal filter to the four columns on either side of 4×4 block vertical boundaries in blocks 417₁, 417₂, 417₃, 417₄, 417₅, 417₆, 419₁ and 419₃ (bands 1301, 1302, 1303, 1304, 1305). The filtering engine 420 applies the horizontal filter to the pixels in band 1306 when the next macroblock is reconstructed.

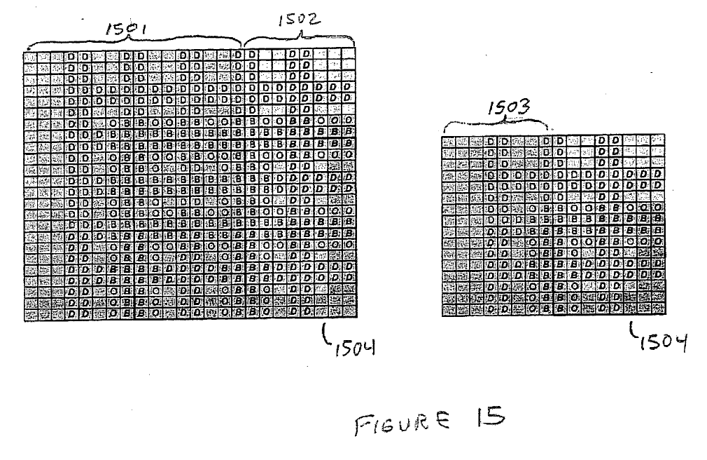

Referring now to FIG. 14, there is illustrated a block diagram describing the overlap transform and deblocking results.

Referring now to FIG. 15, there is illustrated a block diagram describing the portions of the working memory 415 that are saved. The left ⅔ (band 1501), blocks stored in memory 417₁, 417₂, 417₄, 417₅, 417₇, and 417₈ are saved to external memory. The right ⅓ (band 1502), blocks stored in memory 417₃, 417₆, and 417₉, are kept in the working memory 415 for use during the next macroblock. For the chroma pixels, the pixels stored in 419₁, and 419₃ (band 1503) are saved in external memory. In certain embodiments of the present invention, the pixels in band 1504 can be saved with additional precision for the values therein.

The embodiments described herein may be implemented as a board level product, as a single chip, application specific integrated circuit (ASIC), or with varying levels of the decoder system integrated with other portions of the system as separate components.

The degree of integration of the decoder system may primarily be determined by the speed and cost considerations. Because of the sophisticated nature of modern processor, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware. Alternatively, the functions can be implemented as hardware accelerator units controlled by the processor. For example, the symbol interpreter 415, the ISQT 425, spatial predictor 420, motion compensatory 430, pixel reconstructor 435, and display engine 445 can be hardware accelerators under the control of a central processing unit (CPU). The CPU can perform a number of functions, including the management of off-chip DRAM that is allocated to the video decoder 400.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on VC-1 encoded video data, the invention can be applied to a video data encoded with a wide variety of standards.

Therefore, it is intended that the present invention not be limited to the particular embodiment disclosed, but that the present invention will include all embodiments falling within the scope of the appended claims.

1. A method for overlap transforming a macroblock, comprising four blocks, said method comprising:
overlap transform filtering a portion of a horizontal edge of a block; and
overlap transform filtering a vertical edge of the block after filtering the portion of the horizontal edge of the block.

2. The method of claim 1, wherein the vertical edge is a right vertical edge of the block.

3. The method of claim 2, further comprising:
overlap transform filtering a left vertical edge of the block before overlap transform filtering a portion of the horizontal edge of the block.

4. The method of claim 1, further comprising:
overlap transform filtering a remainder of the horizontal edge after filtering the vertical edge.

5. The method of claim 1, wherein the horizontal edge of the block is a top horizontal edge, said method further comprising:
overlap transform filtering a portion of a bottom horizontal edge before filtering the vertical edge.

6. The method of claim 5, further comprising:
overlap transform filtering a remainder of the bottom horizontal edge after filtering the vertical edge.

7. The method of claim 1, further comprising:
deblocker transforming a portion of the horizontal edge before overlap transform filtering the vertical edge of the block.

8. An integrated circuit for overlap transforming a macroblock, comprising four blocks, said integrated circuit comprising:
a controller; and
a memory connected to the controller, said memory storing a plurality of instructions that are executable by the processor, wherein execution of the instructions by the processor causes:
overlap transform filtering a portion of a horizontal edge of a block; and
overlap transform filtering a vertical edge of the block after filtering the portion of the horizontal edge of the block.

9. The integrated circuit of claim 8, wherein the vertical edge is a right vertical edge of the block.

10. The integrated circuit of claim 9, wherein execution of the plurality of instructions also causes:
overlap transform filtering a left vertical edge of the block before overlap transform filtering a portion of the horizontal edge of the block.

11. The integrated circuit of claim 8, wherein execution of the plurality of instruction also causes:
overlap transform filtering a remainder of the horizontal edge after filtering the vertical edge.

12. The integrated circuit of claim 11, wherein the horizontal edge of the block is a top horizontal edge, and wherein execution of the plurality of instructions also causes:
overlap transform filtering a portion of a bottom horizontal edge before filtering the vertical edge.

13. The integrated circuit of claim 12, wherein execution of the instructions also causes:
overlap transform filtering a remainder of the bottom horizontal edge after filtering the vertical edge.

14. The integrated circuit of claim 8, wherein execution of the instructions also causes:
deblocker transforming a portion of the horizontal edge before overlap transform filtering the vertical edge of the block.
